(19) United States
(12) Patent Application Publication
(10) Pub. No.: US 2014/0198508 A1
(43) Pub. Date: Jul. 17, 2014

(54) WIDE-ANGLE ILLUMINATION DEVICE

(71) Applicant: Li -Hsiang Perng, Kaohsiung (TW)

(72) Inventor: Li -Hsiang Perng, Kaohsiung (TW)

(21) Appl. No.: 13/741,524

(22) Filed: Jan. 15, 2013

(51) Int. Cl. F21V 13/00

(52) U.S. Cl. CPC F21V 13/00
USPC 362/311.02

(57) ABSTRACT

Disclosed is a wide-angle illumination device including a base, a conical structure, a fixing structure, at least one light emitting diode and a lampshade, and the fixing structure is provided for fixing the conical structure onto the base, and the conical structure has at least three triangular sides and a top, and the light emitting diodes are disposed on the top and each side respectively. The top and each side are aligned towards different directions to form projection surfaces of different angles and expand the illumination range of the light emitting diodes, so as to achieve a wide-angle illumination effect while enhancing the luminance and the light uniformity.

### BACKGROUND OF THE INVENTION

1. Field of the Invention The present invention relates to a wide-angle illumination device, and more particularly to the wide-angle illumination device capable of providing a wide-angle illumination effect as well as improving luminance and light uniformity.

2. Description of the Related Art In recent years, the issue of global warming becomes increasingly more serious, so that various green products for power saving and carbon reduction attract increasingly more attentions. As to light bulbs, the conventional incandescent bulbs are used extensively, but the incandescent bulbs consume and convert approximately 90% of the light energy into heat energy in a light emitting process, and only 10% of the light energy is used, so that the light emitting efficiency is very low, and such light bulbs causes a significant waste of energy.

In view of the issue of the low light emitting efficiency of the incandescent bulb, manufacturers introduced various light emitting units to replace the incandescent bulbs, and one of the light emitting units is a light emitting diode (LED) having the advantages of high brightness, power saving, green and long service life, and the discharge of carbon dioxide can be reduced in the LED manufacturing process, not only lowering the cost effectively, but also achieving the effect of reducing environmental pollutions.

In the structure of a conventional LED light bulb, a light emitter and a lampshade are sequentially installed on a screw connector, wherein the light emitter is a flat printed circuit board and an LED light emitting unit is installed on the printed circuit board. However, the LED light source is a direct light, so that when the LED light emitting unit is installed on the flat printed circuit board, the LED light emitting unit can project the light in a single direction only, and a general LED light emitting unit has a light emitting angle of approximately 120 degrees, so that the illumination range is small, and the light of the LED light emitting unit cannot be projected to the sides and the bottom of the lampshade easily. As a result, the brightness at the side and the bottom of the transparent lampshade is very low, and the overall illumination effect is poor. Obviously, the conventional LED light bulbs require further improvements.

### SUMMARY OF THE INVENTION

Therefore, it is a primary objective of the present invention to overcome the problems by providing a wide-angle illumination device that provides a wide-angle illumination effect, while improving the luminance and light uniformity.

To achieve the aforementioned objective, the present invention provides a wide-angle illumination device, comprising a base, a conical structure, a fixing structure, at least one light emitting diode and a lampshade, wherein the fixing structure is provided for fixing the conical structure onto the base, and the conical structure has at least three triangular sides and a top, and the light emitting diodes are disposed on the top and each side respectively, and the lampshade is covered onto the base.

Based on the aforementioned structure, the top and each side are aligned towards different directions to form projection surfaces of different angles and expand the illumination range of the light emitting diodes, so as to achieve a wide-angle illumination effect, while improving the luminance and the light uniformity.

### BRIEF DESCRIPTION OF THE DRAWINGS

FIG. 1 is a perspective view of a wide-angle illumination device of a first preferred embodiment the present invention;

FIG. 2 is a top view of a wide-angle illumination device of the first preferred embodiment the present invention;

FIG. 3 is a side view of a wide-angle illumination device of the first preferred embodiment the present invention;

FIG. 4 is perspective view of a wide-angle illumination device of a second preferred embodiment the present invention;

FIG. 5 is a top view of a wide-angle illumination device of the second preferred embodiment the present invention;

FIG. 6 is perspective view of a wide-angle illumination device of a third preferred embodiment the present invention;

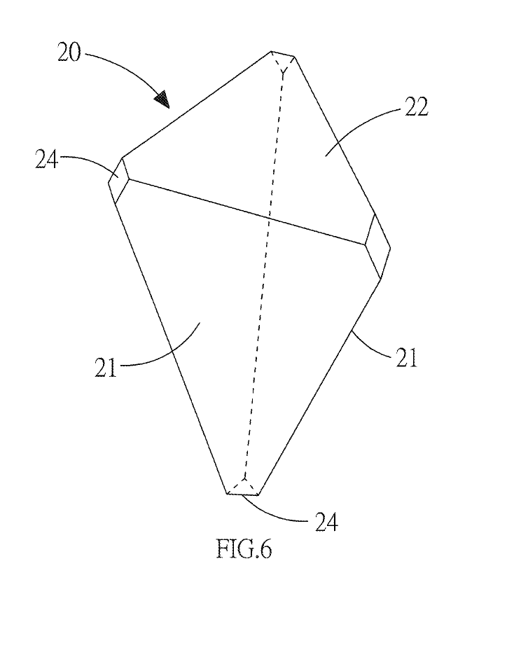

FIG. 7 is perspective view of a wide-angle illumination device of a fourth preferred embodiment the present invention.

### DETAILED DESCRIPTION OF THE PREFERRED EMBODIMENTS

The technical content of the present invention will become apparent with the detailed description of preferred embodiments and the illustration of related drawings as follows. It is noteworthy that same numerals used in the following preferred embodiments and related drawings represent respective elements of the invention.

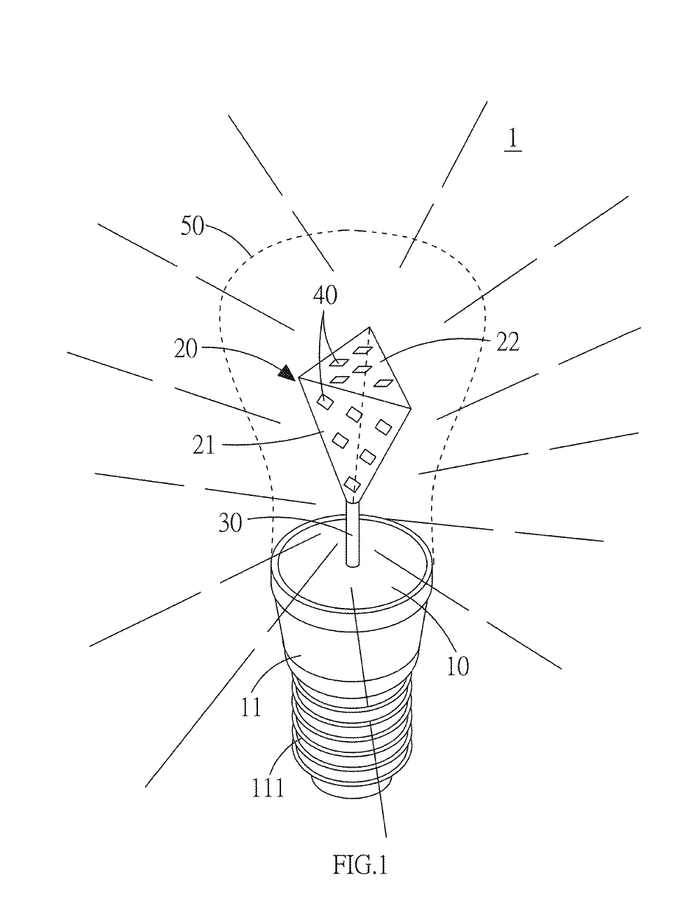

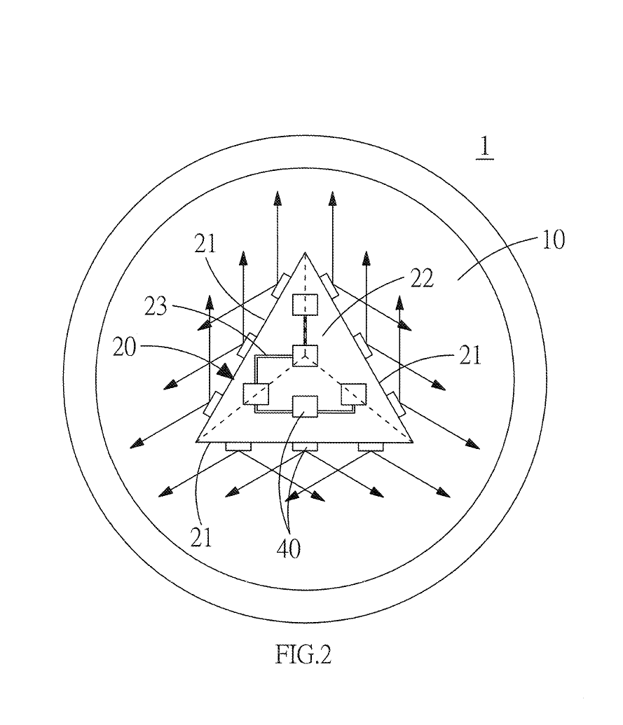

With reference to FIGS. 1 and 2 for a perspective view and a top view of a wide-angle illumination device of the first preferred embodiment of the present invention respectively, the wide-angle illumination device 1 comprises a base 10, a conical structure 20, a fixing structure 30, at least one light emitting diode 40 and a lampshade 50.

In this preferred embodiment, the wide-angle illumination device 1 is a light bulb, and the base 10 further includes a screw connector 11 disposed at the bottom of the base 10, and the screw connector 11 has a thread portion 111 formed at the bottom of the screw connector 11 for screwing to a general power socket to obtain an electric power source.

The conical structure 20 is disposed on the base 10 as shown in the figures, and the conical structure 20 is a triangular pyramid having three triangular sides 21 and a triangular top 22, and the top 22 and each side 21 are connected to each others through corresponding edges, and the top 22 is aligned towards the top of the base 10, and the three sides 21 are aligned towards the bottom of the base 10. The fixing structure 30 is provided for fixing the conical structure 20 onto the base 10, wherein the fixing structure 30 is a column-shaped structure combined with a distal point at the bottom of the conical structure 20 by soldering or adhesion, and the fixing structure is a metal column or a heat pipe capable of enhancing the heat dissipation effect.

The at least one light emitting diode 40 is disposed at the top 22 and each side 21, wherein the top 22 and each side 21 come with a printed circuit board structure made of a ceramic, polycarbonate (PC) or metal material. The printed circuit board has at least one circuit 23 formed on a surface of the printed circuit board for electrically coupling each light emitting diode 40, and each light emitting diode 40 is electrically coupled to a circuit 23 by a chip on board (COB) method.

The lampshade 50 is covered onto the base 10.

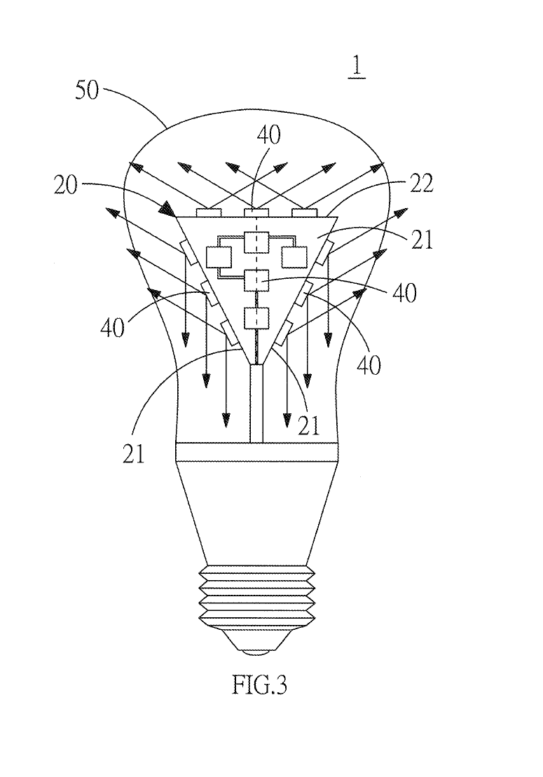

With reference to FIG. 3, the top 22 is aligned towards the top, so that each light emitting diode 40 on the top 22 form an upward illumination range of approximately 120 degrees, and the sides 21 are connected to one another and aligned towards three different direction respectively, so that each light emitting diode 40 of each side 21 is aligned separately towards three different directions to form a downward illumination range of approximately 120 degrees, so that lights can be projected onto a side and the bottom of the lampshade 50 to form projection surfaces of different angles and expand the illumination range of the light emitting diodes, so as to achieve a wide-angle illumination effect, while enhancing the luminance and the light uniformity. In addition, the illumination device of the present invention can be applied to crystal lamps to achieve a better illumination effect.

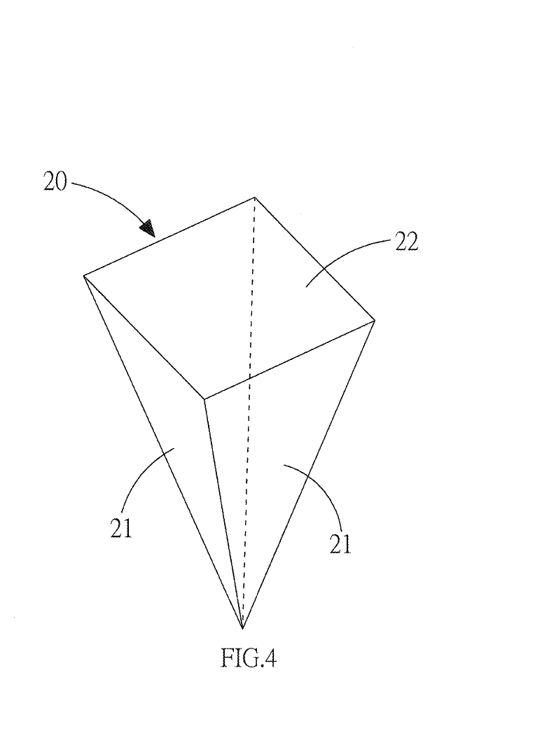

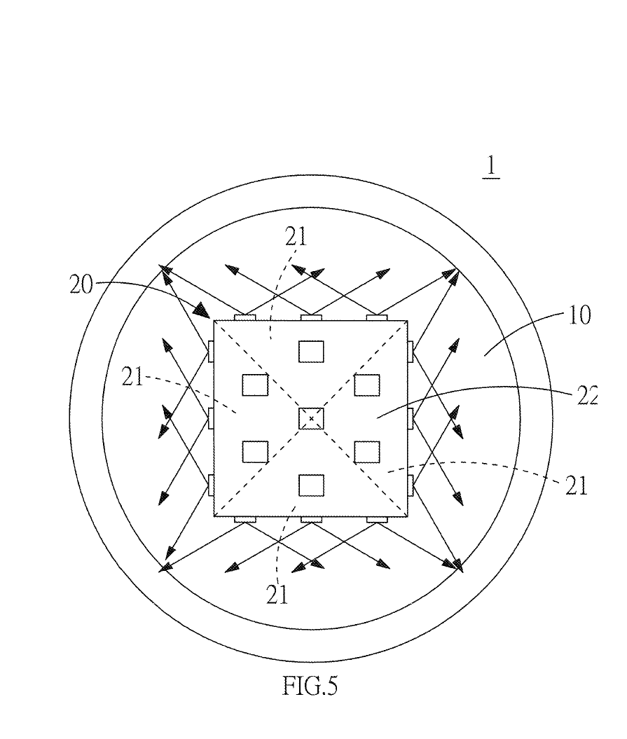

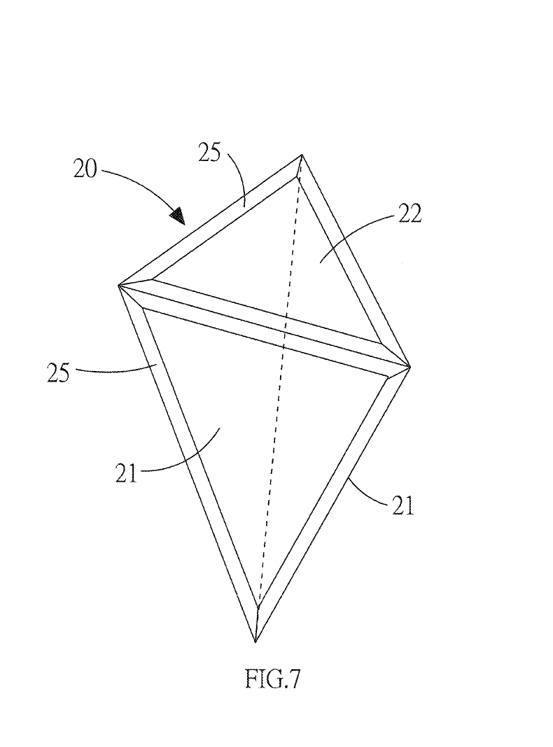

In the second preferred embodiment as shown in FIGS. 4 and 5, the conical structure 20 is a quadrangular pyramid having four triangular sides 21, and a square top 22. Similarly, the top and each side are aligned towards different directions to form projection surfaces of different angles. In the third preferred embodiment as shown in FIG. 7, a chamfer 24 is formed at an intersection of the top 22 and each side 21 of the conical structure 20, and a chamfer 24 is also formed at an intersection of each side 21. In the fourth preferred embodiment as shown in FIG. 8, an oblique surface 25 is inwardly formed at a corresponding connecting edge of the top 22 and each side 21 of the conical structure 20, and an oblique surface 25 is inwardly formed at a corresponding connecting edge of each side 21 for facilitate assembling the conical structure 20.

What is claimed is:

1. A wide-angle illumination device, comprising:
a base;
a conical structure, disposed on the base, and having at least three triangular sides and a top, and the top and each side being coupled by corresponding edges respectively, and the top being aligned towards the top of the base, and the three sides being aligned towards the bottom of the base;
a fixing structure, capable of fixing the conical structure onto the base;
at least one light emitting diode, disposed at the top and each side; and
a lampshade, covered onto the base.

2. The wide-angle illumination device of claim 1, wherein the top and each side come with a printed circuit board structure, and the printed circuit board having at least one circuit formed on a surface of the printed circuit board for electrically coupling each light emitting diode.

3. The wide-angle illumination device of claim 2, wherein each light emitting diode is electrically coupled to a circuit by a chip on board (COB) method.

4. The wide-angle illumination device of claim 2, wherein the printed circuit board structure is made of a material selected from the collection of ceramic, polycarbonate (PC) and metal.

5. The wide-angle illumination device of claim 1, wherein the base further includes a screw connector disposed at the bottom of the base, and the screw connector has a thread portion formed at the bottom of the screw connector.

6. The wide-angle illumination device of claim 1, wherein the fixing structure is a metal column structure or a heat pipe structure.

7. The wide-angle illumination device of claim 1, wherein the conical structure is a triangular pyramid having three triangular sides and a triangular top.

8. The wide-angle illumination device of claim 1, wherein the conical structure is a quadrangular pyramid having four triangular sides, and a square top.

9. The wide-angle illumination device of claim 1, wherein the conical structure has a chamfer formed at an intersection of the top and each side, and a chamber formed at an intersection of each side.

10. The wide-angle illumination device of claim 1, wherein the conical structure has an oblique surface inwardly formed at a corresponding connecting edge of the top and each side, and each corresponding connecting edge of each side has an oblique surface inwardly formed at a corresponding connecting edge of each side.
